(19) United States
(12) Patent Application Publication
(10) Pub. No.: US 2012/0274913 A1
(43) Pub. Date: Nov. 1, 2012

(54) ENHANCED CONTRAST PIN MIRROR FOR LITHOGRAPHY TOOLS

(75) Inventor: Daniel Gene Smith, Tucson, AZ (US)

(73) Assignee: NIKON CORPORATION, TOKYO (JP)

(21) Appl. No.: 13/097,578

(22) Filed: Apr. 29, 2011

(51) Int. Cl. G03B 27/42; G03B 27/32

(52) U.S. Cl. 355/53; 355/77

(57) ABSTRACT

A contrasting surface surrounding the pin minor when measuring aberrations of a lithographic projection system. By using a surrounding surface having a different reflectivity characteristic relative to the pin minor, the reflected wave front contains predominately single-pass aberration content because the amount of double-pass content is significantly reduced. As a result, the aberration measurement performed by a measurement system is more accurate.

### BACKGROUND

1. Field of the Invention

This invention relates to photolithography, and more particularly, to an enhanced contrast pin mirror used for measuring aberrations of a projection lens system in a photolithography tool.

2. Description of Related Art

Photolithography is a well-known technique for fabricating patterns onto substrates, such as semiconductor wafers or LCD panels. Photolithography tools typically include a light source, a substrate stage for holding a substrate to be pattered, a projection lens system, and a reticle stage, which holds a reticle defining the pattern to be projected onto the substrate. During operation, a substrate covered with a light-sensitive material, such as photoresist, is placed on the substrate table. The projection lens system then projects light from the light source through the reticle onto the substrate, resulting in the pattern being formed on the light-sensitive material. In a series of subsequent chemical and/or etching steps, the pattern defined by the reticle is formed on the substrate under the pattern photoresist. By repeating the above process multiple times, the complex circuitry of semiconductor wafer, or the pixels of an LCD display panel, may be created on a substrate.

The feature sizes of the patterns defined on current semiconductor wafers and LCD panels are extremely small, and will continue to get even smaller in the future. To achieve these small feature sizes, the optics of the projection lens system needs to be highly precise. Any aberrations in the optics may result in the blurring and/or overlay of the images formed on the substrate.

One known technique for measuring aberrations involves the imaging of a pinhole reticle onto a pin minor and surrounding surface on the substrate table, which causes a spatially filtered spherical wave front to be reflected back through the projection lens system. A measurement system then measures the reflected wave front to determine if aberrations are present in the optics of the projection lens system. If no aberrations are present, then the returned wave front is spherical. On the other hand, if aberrations are present, then the (i) the center of curvature of the returned wave front may be displaced and/or (ii) the returned wave front may (i) not be spherical. The amount of aberration in the projection lens system is largely determined by the degree the returned wave front is spherical or not, as well as the position of the center of curvature.

Several problems exist with the aforementioned technique for measuring aberrations. The pin mirror tends to be small relative to the surrounding surface on the substrate table. In addition, the surface area surrounding the pin mirror is typically made of fused silica, which has a reflectivity characteristic very similar to that of the pin minor at high angles of incidence. As a result, the aberration content contained in the reflected wave front includes components reflected off both the pin minor and the surrounding area. With both components present in the wave front, the resulting measurement performed by the measurement system will contain a mix of information; including (i) a wave front that is spatially filtered by the pinhole so that it effectively traversed the projection lens system once, in a so-called “single-pass” and (ii) a wave front that is unfiltered by reflection from the surrounding substrate so that it traversed the projection optics twice, in a so-called “double-pass”.

With the double-pass component, certain aberrations will double on the second pass, while other aberrations will cancel entirely. An aberration measurement performed on a reflected wave front containing a significant double-pass component may be inaccurate. A reflected wave front containing mostly single-pass aberration content with reduced double-pass content is therefore desirable when performing aberration measurements of the projection lens system.

### SUMMARY OF THE INVENTION

When measuring aberrations of a lithographic projection system, the problem of poor contrast of reflectivity when analyzing the wave front of a pinhole image reflected off a pin minor and the surrounding surface is solved using a contrasting surface surrounding the pin minor. By using a surrounding surface having a different reflectivity characteristic relative to the pin mirror, the reflected wave front contains predominately single-pass aberration content because the amount of double-pass content is significantly reduced. As a result, the aberration measurement performed by a measurement system is more accurate.

The contrasting surface surrounding the pin minor preferably has a profile that reduces diffraction. In one embodiment, the surface includes a plurality of structures, each having a width small enough to prevent or reduce the diffraction and scatter of the incident radiation back to the pupil of the projection lens system. The proper width of the structures may vary in accordance with a number of variables, such as the wavelength of the light source in the incident medium, the angle of incidence, the maximum angle of illumination, and how much diffracted light can be tolerated by the measurement system. The structures may be a variety of shapes, including hex shaped cones, square shaped pyramids, spires, periodic lines, posts or random structures. In each case, the lateral size of the structures is preferably small enough to reduce scatter, while defining a gradual transition in the Z-direction, resulting in a reduction in reflectivity.

The contrasting surface may be advantageously used with both conventional “dry” lithography tools and immersion lithography tools. With dry lithography, air is the incident medium. In the case of immersion lithography, an immersion fluid, such as deionized water, is the incident medium. With the latter, the structures of the surrounding area may be formed in fused silica. By using fused silica, the surrounding surface provides all the advantages of an anti-reflective surface, but without the disadvantages of anti-reflective multilayer coatings that breakdown and cause contamination when exposed to deionized water.

### BRIEF DESCRIPTION OF THE DRAWINGS

The invention may best be understood by reference to the following description taken in conjunction with the accompanying drawings, which illustrate specific embodiments of the invention.

FIGS. 1A and 1B are system diagrams of a lithography tool using a contrasting surrounding surface in accordance with the invention.

FIGS. 2A and 2B are diagrams of a surrounding surface material according to a first embodiment of the invention.

FIGS. 3A and 3B are diagrams of a surrounding surface material according to a second embodiment of the invention.

FIGS. 4A and 4B are diagrams of a surrounding surface material according to a third embodiment of the invention.

FIGS. 5A and 5B are flow charts that outline a process for designing and making a substrate device.

FIGS. 6A and 6B are diagrams of substrate table with an integral pin minor in accordance with two different embodiments of the invention.

It should be noted that like reference numbers refer to like elements in the figures.

### DETAILED DESCRIPTION OF SPECIFIC EMBODIMENTS

The invention will now be described in detail with reference to various embodiments thereof as illustrated in the accompanying drawings. In the following description, specific details are set forth in order to provide a thorough understanding of the invention. It will be apparent, however, to one skilled in the art, that the invention may be practiced without using some of the implementation details set forth herein. It should also be understood that well known operations have not been described in detail in order to not unnecessarily obscure the invention.

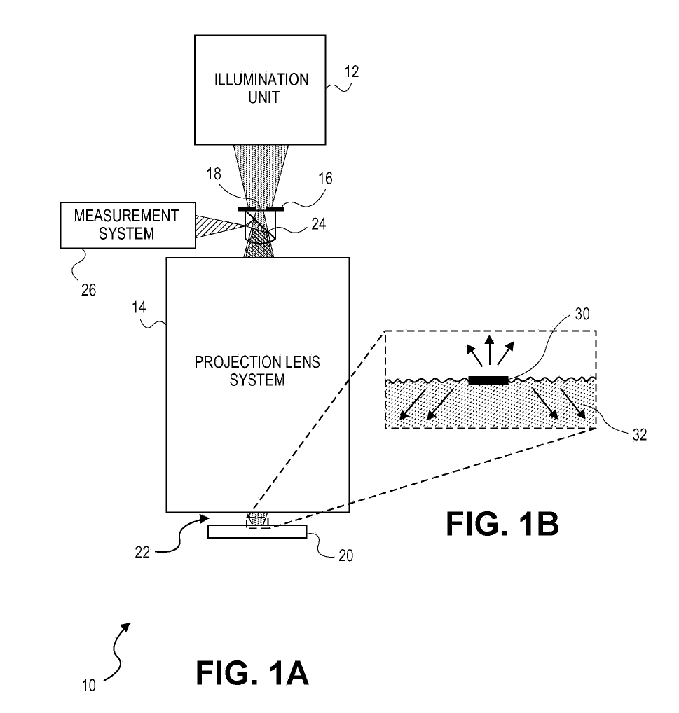

Referring to FIG. 1A, a lithography tool 10 of the invention is illustrated. The tool 10 includes an illumination unit 12, a projection lens system 14, a reticle 16 defining a pinhole 18, and a substrate table 20 positioned under, but separated from, the projection lens system 14 by a medium 22. A beam splitter 24 is provided adjacent the reticle 16. A measurement system 26 is provided in optical proximity to the beam splitter 24. In one embodiment, the lithography tool 10 is a conventional “dry” lithography tool and the medium 22 is air. In an alternative embodiment, the tool 10 is an immersion lithography tool and the medium 22 is an immersion fluid, such as deionized water. In various other embodiments, the measurement system 26 may be any type of wave front measuring system, such as but not limited to, a metrology system, a Talbot interferometer, a point diffraction interferometer, a Shack-Hartmann wave front sensor, a “knife-edge” test sensor, a curvature sensor, or any other type of measurement system capable of providing information about the shape of a wave front.

Referring to FIG. 1B, an exploded view of a pin minor 30 and surrounding surface 32 on the substrate table 20 is illustrated. The pin mirror 30 has a first reflectivity characteristic and the surrounding surface 32 has a second reflectivity characteristic that is in contrast with the reflectivity of the pin minor. During an aberration measurement, the projection lens system 14 projects radiation passing through the pinhole 18 from the illumination unit 12 onto the pin minor 30 and surrounding surface 32. Arrows are used to represent the different or contrasting reflectivity characteristics of the two surfaces. The upward pointing arrows represent the reflection of incident radiation off the pin mirror 30. The downward pointing arrows represent the incident radiation passing through the contrasting surrounding surface 32, as opposed to reflecting off the surface 32. The result is a spatially filtered wave front that is predominately reflected by the pin minor 30, but substantially transmitted by the surrounding surface 32. The reflected wave front arriving at the measurement system 26 consequently contains predominately single-pass aberration content, with the amount of double-pass content significantly reduced.

In one non-exclusive embodiment, the surface 32 has a surface profile that defines a gradual transition with the incident medium 22, resulting in a reduction in the reflection, diffraction and/or scatter of radiation from the illumination unit 12 when the pinhole image 18 is projected by the projection lens system 14. The gradual transition is created by a plurality of small structures formed on the surrounding surface 32 that produce a gradual change in the index of refraction with the incident medium 22 across the surface 22.

In one non-exclusive embodiment, the contrasting surface 32 surrounding the pin minor 30 is made up of a plurality of structures formed in fused silica. The structures each have a relatively wide base, but taper in width as the structure extends in the Z direction into the incident medium 22. With a tapered shape, each structure defines a gradual transition with the incident medium 22. The gradual transition results in a gradual change in the index of refraction between the incident medium 22 and the surface 32. In addition, the more gradual the transition (e.g., the more the structure extends in the Z direction), the better the transmissivity.

In various embodiments, the width of the structures may vary, depending on the wavelength used by the illumination unit 12 when imaging the pinhole. The proper width of the structures may vary in accordance with a number of variables, such as the wavelength of the light source in the incident medium, the angle of incidence, the maximum angle of illumination, and how much diffracted light can be tolerated by the measurement system. In one non-exclusive embodiment, with light of 193 nanometers, the structures may preferably have a width of less than one quarter of the wavelength in the incident medium to significantly reduce back scatter by diffraction. Again it should be noted that this width may or may not be proper, depending on the variables listed above. By defining the width of the structures relative to the wavelength, diffraction and/or scatter off the surface 32 may be reduced.

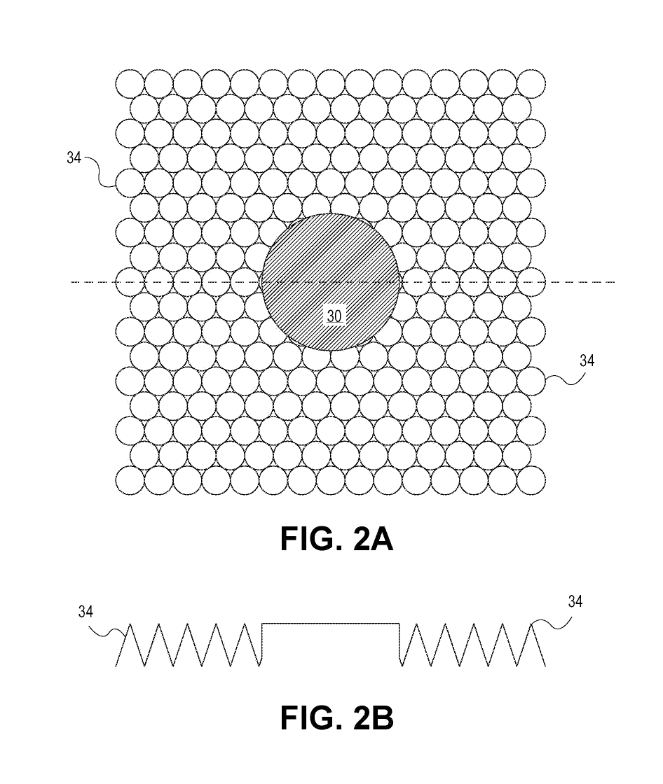

Referring to FIGS. 2A and 2B, a top view and a cross-section view of a plurality of structures of the surrounding surface 32 is shown. In this example, the individual structures 34 are cone shaped.

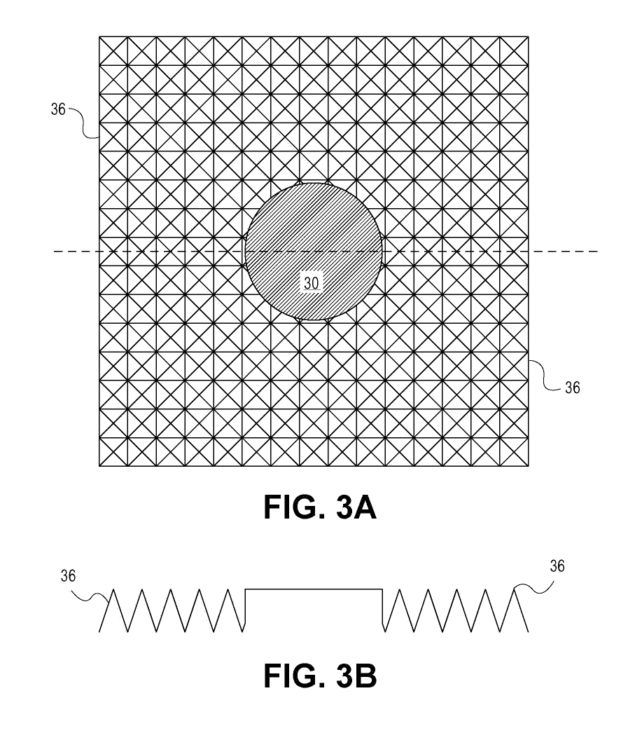

Referring to FIGS. 3A and 3B, a top view and a cross-section view of a plurality of structures of the surrounding surface 32 is shown. In this example, the individual structures 36 are pyramid shaped.

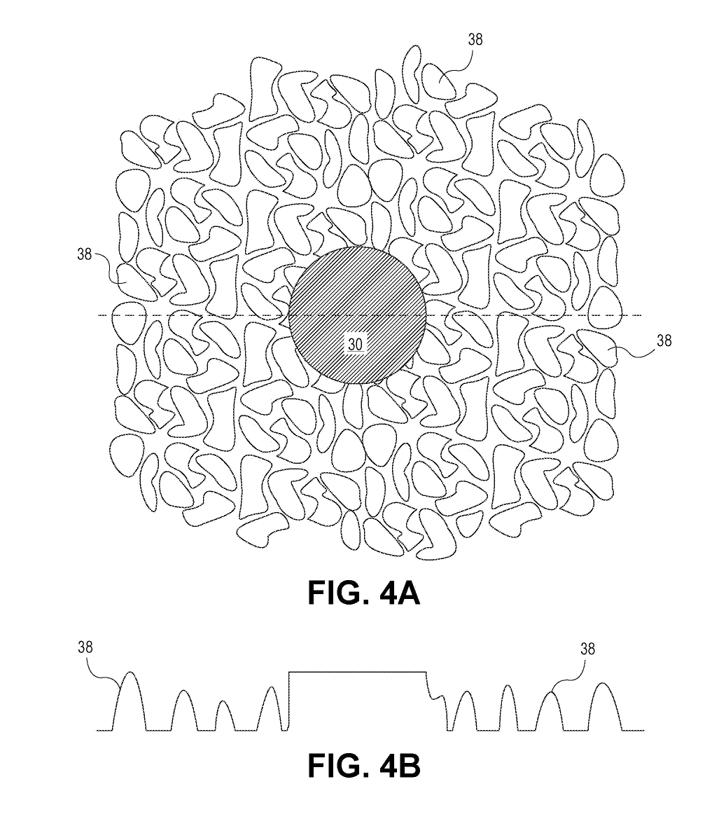

Referring to FIGS. 4A and 4B, a top view and a cross-section view of a plurality of structures of the surrounding surface 32 is shown. In this example, the individual structures 38 are random shaped with no periodicity having a period shorter than the size of the spot illuminating the pin mirror.

The embodiments illustrated in FIGS. 2A-2B, 3A-3B and 4A-4B are meant to be exemplary. In no way should these specific shapes be construed as limiting. Rather according to different embodiments, the structures may be a variety of shapes, including hex shaped cones, square shaped pyramids, spires, periodic lines, posts or random structures. In each case, the lateral size of the structures is preferably small enough to reduce scatter, while defining a gradual transition in the Z-direction, resulting increased transmissivity and a reduction in reflectivity.

During an aberration measurement, the image defined by the pinhole 18 is projected by the projection lens system 14 through medium 22 onto the pin mirror 30 and surrounding surface 32. The resulting wave front, which is substantially reflected off the pin minor 30, but not the surrounding surface 32, contains predominately single-pass aberration content, but not double-pass content. As a result, the aberration measurement performed by a measurement system 26 is more accurate since the amount of double-pass content that is either cancelled or doubled is significantly reduced.

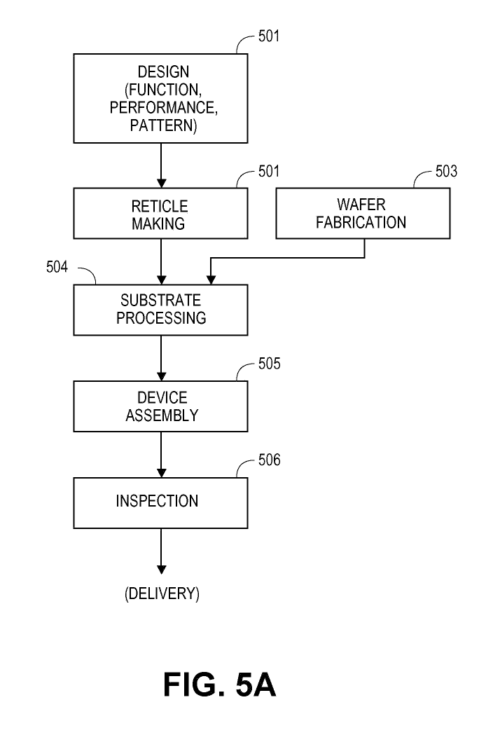

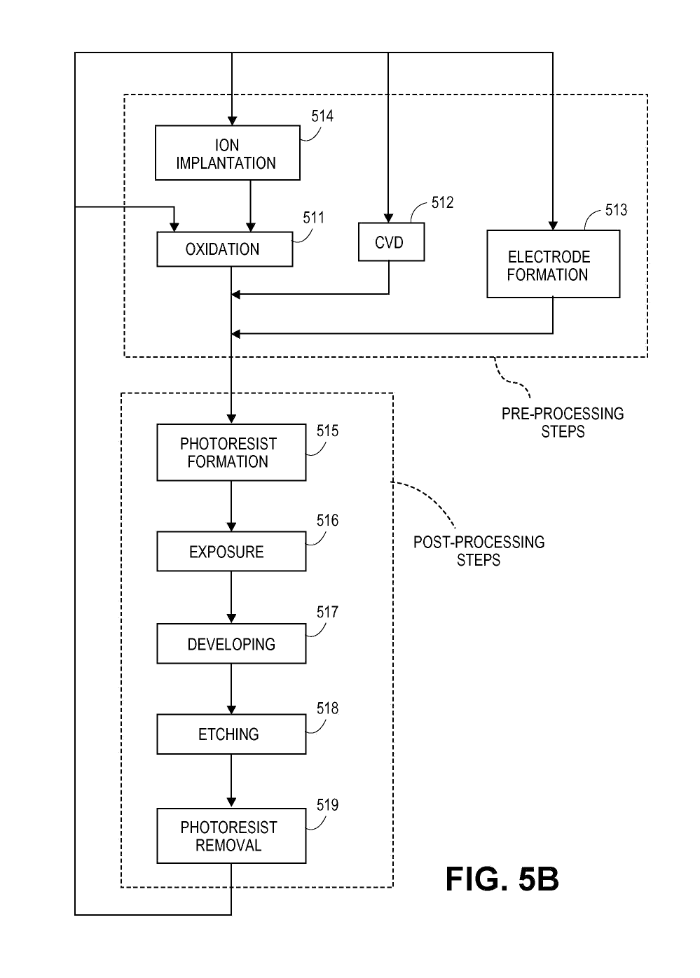

Devices, such as semiconductor die on a wafer or LCD panels, are fabricated by the process shown generally in FIG. 5A. In step 501 the function and performance characteristics of the device are designed. In the next step 502, one or more reticles, each defining a pattern, are developed according with the previous step. In a related step 503 a “blank” substrate, such as a semiconductor wafer or glass panel, is made and prepared for processing. The substrate is then processed in step 504 at least partially using the photolithography system 10 as described herein. In step 505, the device is assembled and then inspected in step 506.

FIG. 5B illustrates a detailed flowchart example of the above-mentioned step 504 in the case of fabricating semiconductor devices. In step 511 (oxidation step), the substrate wafer surface is oxidized. In step 512 (CVD step), an insulation film is formed on the wafer surface. In step 513 (electrode formation step), electrodes are formed on the wafer by vapor deposition. In step 514 (ion implantation step), ions are implanted in the wafer. The above-mentioned steps 511-514 form the preprocessing steps for wafers during wafer processing, and selection is made at each step according to processing requirements.

At each stage of wafer processing, when the above-mentioned preprocessing steps have been completed, the following post-processing steps are implemented. During post-processing, first, in step 515 (photoresist formation step), photoresist is applied to a wafer. Next, in step 516 (exposure step), the tool 10 is used to transfer the circuit pattern of the reticle to the wafer. Then in step 517 (developing step), the exposed wafer is developed, and in step 518 (etching step), parts other than residual photoresist (exposed material surface) are removed by etching. In step 519 (photoresist removal step), unnecessary photoresist remaining after etching is removed. Multiple circuit patterns are formed by repetition of these preprocessing and post-processing steps. Although not described herein, the fabrication of LCD panels from glass substrates is performed in a similar manner.

In accordance with different embodiments, aberration measurements of the projection lens system 14 may be performed at various times. For example, an aberration measurement may be performed before a tool 10 is delivered to a customer site where the tool was designed and made. Measurements can also be performed after the tool 10 is initially delivered to a substrate fabrication facility, but before substrate fabrication begins. Once the tool 10 is being used for substrate fabrication, periodic aberration measurements may also be performed at various times. For example, a measurement may be performed one or more times per substrate, hour, day, week, month, or any other time interval. After each measurement, steps to correct any measured aberrations of the projection lens system 14 may be made as needed.

In settings where aberration measurements are likely to be performed numerous times, it would be convenient to have a tool 10 that is flexible and conducive to performing the measurements without too much interruption.

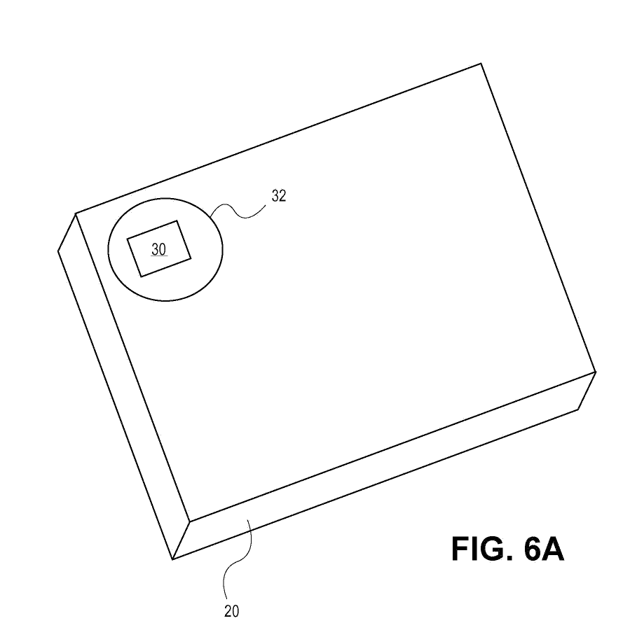

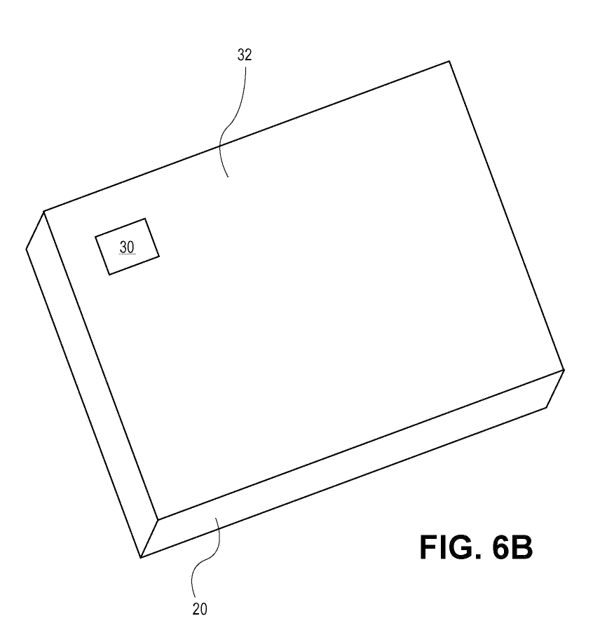

FIG. 6A illustrates one embodiment where the pin minor 30 and the surrounding surface 32 are positioned in a typically unused area on the substrate table 20, such as a corner. In this example, a small glass square, approximately 10 mm by 10 mm defining the pin mirror 30, is rigidly attached to a corner of the table 20. The surrounding surface 32 is formed by fused silica, also rigidly attached to the table 20, surrounding the pin minor 30. In an alternative embodiment of FIG. 6B, the pin mirror 30 is rigidly attached to an unused portion of the table 20, which is made of silicon carbide. Since silicon carbide is not a reflective material, however, it provides the contrasting surface 32, elimination the need for providing an additional anti-reflective surface. In either case, the stage 20 is simply moved to the corner position when an aberration measurement is to be performed.

It should be noted that it is not necessary for the pin mirror 30 to be positioned in a corner of the table 20. Rather in various embodiments, the pin mirror 30 may be positioned anywhere on the table 20. In addition, the pin mirror 30 and possibly the surface 32 also do not need to be rigidly attached to the table 20. In alternative embodiments, either or both the pin minor 30 and surface 32 may be removable and use only when an aberration measurement is to be performed.

In yet other embodiments, one or more anti-reflective coatings surrounding the pin mirror 30 may be used to form the surface 32. With this embodiment, the anti-reflective coatings may periodically be reapplied if the material needs to be replaced.

The tool 10 may be advantageously used with both conventional “dry” lithography tools and immersion lithography tools. With dry lithography, air is the incident medium 22. In the case of immersion lithography, an immersion fluid, such as deionized water, is the incident medium 22. With the latter, either the fused silica or silicon carbide surfaces provides the advantages of an anti-reflective surface, but without the disadvantages of anti-reflective coatings that breakdown and cause contamination when exposed to deionized water.

Although many of the components and processes are described above in the singular for convenience, it will be appreciated by one of skill in the art that multiple components and repeated processes can also be used to practice the techniques of the system and method described herein. Further, while the invention has been particularly shown and described with reference to specific embodiments thereof, it will be understood by those skilled in the art that changes in the form and details of the disclosed embodiments may be made without departing from the spirit or scope of the invention. For example, embodiments of the invention may be employed with a variety of components and should not be restricted to the ones mentioned above. It is therefore intended that the invention be interpreted to include all variations and equivalents that fall within the true spirit and scope of the invention.

What is claimed is:

1. A lithographic tool, comprising:
a projection system configured to project a pinhole image onto a pin minor having a first reflectivity characteristic and a surrounding surface having a second reflectivity characteristic in contrast with the first reflectivity characteristic; and
a measurement system configured to measure aberrations of the projection system at least based in part on the measured reflection of the pinhole image off the pin mirror having the first reflectivity characteristic and the surrounding surface having the second reflectivity characteristic in contrast with the first reflectivity characteristic.

2. The tool of claim 1, wherein the surrounding surface is more transmissive relative to the pin minor.

3. The tool of claim 1, wherein the surrounding surface has a surface profile that defines a gradual transition from the incident medium into the medium that supports the pinhole.

4. The tool of claim 1, wherein the surrounding surface defines a plurality of structures formed on the surface, the plurality of structures having a width that tapers in the direction toward the medium that transmits the pinhole image.

5. The tool of claim 4, wherein the plurality of structures comprise one of the following: hex shaped cones, square shaped pyramids, spires, periodic lines, posts, random structures, or any combination thereof.

6. The tool of claim 1, wherein the surface surrounding the pin mirror is fused silica.

7. The tool of claim 1, wherein the surface surrounding the pin mirror is an anti-reflective coating.

8. The tool of claim 1, further comprising a substrate table, the pin mirror integrally formed on the substrate table.

9. The tool of claim 1, further comprising a substrate table configured to support the pin mirror, wherein the pin mirror is placed onto the substrate table during aberration measurements.

10. The tool of claim 1, further comprising a substrate table configured to support the surface surrounding the pin minor, wherein the surrounding surface is placed onto the substrate table during aberration measurements.

11. The tool of claim 1, wherein the substrate table comprises silicon carbide.

12. The tool of claim 1, wherein the surface surrounding the pin mirror is silicon carbide.

13. A method of providing a lithography tool, comprising:
providing a projection system capable of projecting a pinhole image onto a pin minor having a first reflectivity characteristic and a surface surrounding the pin minor having a second reflectivity characteristic in contrast with the first reflectivity characteristic; and
providing a measurement system capable of measuring aberrations of the projection system at least based in part on the measured reflection of the pinhole image off the pin minor having the first reflectivity characteristic and the surrounding surface having the second reflectivity characteristic in contrast with the first reflectivity characteristic.

14. The method of claim 13, further comprising configuring the surrounding surface to be more transmissive relative to the pin mirror.

15. The method of claim 13, further comprising providing the surrounding surface with a surface profile that defines a gradual transition with the incident medium that transmits the pinhole image.

16. The method of claim 13, further comprising providing the surrounding surface with a plurality of structures formed on the surface, the plurality of structures having a width that tapers in the direction toward the medium that transmits the pin hole image.

17. The method of claim 16, wherein the provided plurality of structures comprise one of the following: hex shaped cones, square shaped pyramids, spires, periodic lines, posts, random structures, or any combination thereof.

18. The method of claim 13, further comprising providing a substrate table with the pin mirror and surrounding surface integrally formed thereon.

19. The method of claim 13, further comprising providing a substrate table, the substrate table having an area configured to receive the pin mirror when placed on the substrate table during aberration measurements.

20. The method of claim 13, further comprising providing a substrate table, the substrate table having an area configured to receive the surrounding surface when placed on the substrate table during aberration measurements.

21. The method of claim 13, further comprising providing a substrate table to support the pin minor, the provided substrate table comprising silicon carbide.

22. The method of claim 13, wherein the surrounding surface is fused silica.

23. The method of claim 13, further comprising coordinating aberrations measurements of the provided projection lens system using the provided providing measurement system at various times, the various times consisting of one or more of the following:
(i) at the location where the lithography tool is designed and made;
(ii) at a substrate fabrication facility where the lithography tool is used to pattern substrates;
(iii) at predetermined selected times during the patterning of substrates; or (iv) any combination of (i) through (iii).
